(19) United States
(12) Patent Application Publication
(10) Pub. No.: US 2024/0408556 A1
(43) Pub. Date: Dec. 12, 2024

(54) METHOD OF FORMING GRAPHENE OXIDE FILM ON A SUBSTRATE

(71) Applicant: Evercloak Inc., Kitchener (CA)

(72) Inventors: Michael A. POPE, Kitchener (CA); Luzhu XU, Kitchener (CA); Nicholas D. WILSON, Strathroy (CA); Priyanka VERMA, Orangeville (CA)

(73) Assignee: Evercloak Inc., Kitchener, ON (CA)

(21) Appl. No.: 18/291,624

(22) PCT Filed: Jul. 19, 2022
(86) PCT No.: PCT/CA22/51116

§ 371 Date: Jan. 24, 2024

Related U.S. Application Data
(60) Provisional application No. 63/227,594, filed on Jul. 30, 2021.

(51) Int. Cl. B01D 71/02; B01D 69/10

(52) U.S. Cl. CPC B01D 71/0211; B01D 69/107

(57) ABSTRACT

A method of forming a graphene oxide (GO) film on a substrate involves depositing a GO ink on a surface of a porous substrate, and mechanically removing excess ink on the surface of the porous substrate while simultaneously providing a pressure difference that forces a liquid medium of the ink through the porous substrate to provide a GO film on the surface of the porous substrate. The method provides GO membranes having similar water vapor permeance but significantly better selectivity to GO membranes produced by traditional blade casting methods and to GO membranes produced by traditional vacuum filtration methods.

### CROSS-REFERENCE TO RELATED APPLICATIONS

This application claims the benefit of United States Provisional Patent Application U.S. Ser. No. 63/227,594 filed Jul. 30, 2021, the entire contents of which is herein incorporated by reference.

### FIELD

This application relates to graphene oxide (GO) films, substrates having graphene oxide films formed thereon and methods of forming graphene oxide films on substrates.

### BACKGROUND

Graphene oxide laminates (stacked films composed of about 0.7 nm thick single layers of oxidized graphite/graphene) are known to be highly selective to water vapor permeation and capable of blocking or slowing the transport of other liquids, gases and vapors. There is usually a trade-off between high transport rates and selectivity since the selectivity typically suffers as the GO laminate is made thin enough to maximize water permeability and reduce material costs. Thus, processing methods which yield uniform, low-defect laminates exhibiting high water vapor permeance are required to successfully implement various technologies related to membrane-based water management technologies such as air dehumidification, solvent or gas dehydration, membrane-based cooling, liquid phase separations such as reverse osmosis, nano/ultra-filtration and emerging desalination technologies using pervaporation, membrane-gap distillation, etc.

Casting methods such as tape casting (also called doctor blading or knife coating) have been used to cast GO films on various substrates. Tape casting has high throughput and helps to align films, but uses evaporation of the solvent to remove all of the solvent from the film. Evaporative drying leads to membranes having poorer selectivity because the films are not self-limiting (i.e., GO sheets stack randomly leaving different size pores).

Pressure-assisted filtration (e.g., vacuum filtration) is also a technique that has been used to prepare GO films on a substrate. However, vacuum filtration is slow (24-48 hours) and requires high volumes of liquid per unit area of the substrate. Films produced in this way typically yield a good selectivity due to the self-limiting nature of pressure-assisted filtration whereby any flow caused by defects brings more GO to heal the defective region.

There remains a need for methods of producing thin, uniform, low-defect graphene oxide (GO) laminates exhibiting high water vapor permeance and high selectivity for water permeation over other liquids, gases and vapors.

### SUMMARY

A method of forming a graphene oxide (GO) film on a substrate comprises: depositing a GO ink on a surface of a porous substrate; and, mechanically removing excess ink on the surface of the porous substrate while simultaneously providing a pressure difference that forces a liquid medium of the ink through the porous substrate to provide a GO film on the surface of the porous substrate.

A membrane formed by the method comprises a graphene oxide (GO) film on a porous substrate.

In some embodiments, the ink comprises a dispersion of GO in the liquid medium. In some embodiments, the excess ink is removed from a first surface of the porous substrate with a scraping device while simultaneously providing the pressure difference between the first surface and a second surface of the porous substrate to force the liquid medium through the porous substrate to provide the GO film on the first surface of the porous substrate

It has now been found that combining elements of casting techniques (e.g., tape casting) with elements of pressure-assisted filtration (e.g., vacuum filtration) provides GO films that have better selectivity for water vapor vs. other vapors and gases (e.g., nitrogen gas) while maintaining similar permeance (pore size) and film thickness compared to films that were produced by either casting (e.g., tape casting) or pressure-assisted filtration (e.g., vacuum filtration) alone.

Graphene oxide (GO) membranes produced by the present vacuum-assisted casting method are useful in technologies related to membrane-based water management, such as air dehumidification, solvent or gas dehydration, membrane-based cooling, liquid phase separations (e.g., reverse osmosis, nano/ultra-filtration, desalination technologies using pervaporation), membrane-gap distillation, etc.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a schematic diagram of a vacuum-assisted doctor blading method of forming a graphene oxide (GO) film on a flat porous substrate.

FIG. 1B depicts a schematic diagram of a vacuum-assisted doctor blading method of forming a graphene oxide (GO) film on a curved porous substrate such as a tube or hollow fiber.

FIG. 2 depicts images of a GO coating on a nylon-based substrate produced by a vacuum-assisted doctor blading method, where panel a) is an optical photograph of the substrate with the GO coated thereon, panel b) is a scanning electron microscope (SEM) image of the GO coating the substrate showing smooth surface morphology of the coating, and panel c) is a cross-sectional SEM image of the GO coating on the substrate.

FIG. 3A depicts photographs of GO coatings on a nylon-based (nylon) substrate prepared by applying four different pressure differentials, which have been normalized by coating area and reported as a force of 0 N, 155 N, 310 N and 851 N, on the bare substrate during a doctor blading method.

FIG. 3B depicts photographs of GO coatings on a polypropylene (PP) substrate prepared by applying four different pressure differentials, which have been normalized by coating area and reported as a force of 0 N, 155 N, 310 N and 851 N, on the bare substrate during a doctor blading method.

FIG. 3C depicts photographs of GO coatings on a polyacrylonitrile (PAN) substrate prepared by applying four different pressure differentials, which have been normalized by coating area and reported as a force of 0 N, 155 N, 310 N and 851 N, on the bare substrate during a doctor blading method.

FIG. 4A is a graph of water permeance (left axis) and estimated selectivity (right axis) vs. suction force for the nylon-based GO membranes depicted in FIG. 3A, where A is the 0 N sample, B is the 155 N sample, C is the 310 N sample and D is the 851 N sample. The water permeance is shown as a bar chart and the estimated selectivity is shown as a scatter plot.

FIG. 4B is a graph of water permeance (left axis) and estimated selectivity (right axis) vs. suction force for the polypropylene (PP) GO membranes depicted in FIG. 3B, where A is the 0 N sample, B is the 155 N sample, C is the 310 N sample and D is the 851 N sample. The water permeance is shown as a bar chart and the estimated selectivity is shown as a scatter plot.

FIG. 4C is a graph of water permeance (left axis) and estimated selectivity (right axis) vs. suction force for the polyacrylonitrile (PAN) GO membranes depicted in FIG. 3C, where A is the 0 N sample, B is the 155 N sample, C is the 310 N sample and D is the 851 N sample. The water permeance is shown as a bar chart and the estimated selectivity is shown as a scatter plot.

FIG. 5 is a graph of water permeance (left axis) and estimated selectivity (right axis) for a nylon-based GO membrane produced using vacuum-assisted blade casting compared to a GO membrane produced from traditional vacuum filtration using the same suction force. The water permeance is shown as a bar chart and the estimated selectivity is shown as a scatter plot.

FIG. 6A depicts a graph of water permeation (left axis) and estimated selectivity (right axis) for GO membranes prepared by vacuum-assisted blade casting using inks of various concentrations. The water permeance is shown as a bar chart and the estimated selectivity is shown as a scatter plot.

FIG. 6B depicts a graph of water permeation (left axis) and estimated selectivity (right axis) for GO membranes prepared by vacuum-assisted blade casting and having various GO film thicknesses that arise from the inks of various concentrations of FIG. 6A. The water permeance is shown as a bar chart and the estimated selectivity is shown as a scatter plot.

FIG. 7 depicts a graph of water permeation (left axis) and estimated selectivity (right axis) for GO membranes prepared by vacuum-assisted blade and having various types of organic polymeric substrates. The water permeance is shown as a bar chart and the estimated selectivity is shown as a scatter plot.

### DETAILED DESCRIPTION

The method involves depositing a graphene oxide (GO) ink on a porous substrate. The graphene oxide ink comprises a dispersion of GO in a liquid medium. The dispersion is preferably a liquid crystalline GO dispersion. The graphene oxide can be synthesized by known methods, for example Hummers' method, which treats graphite with a mixture of sulfuric acid, sodium nitrate and potassium permanganate, or one of the known improvements to Hummers' method. Bulk graphene oxide is dispersed into the liquid medium to yield monomolecular GO sheets. Dispersion may be aided using sonication. Concentration of GO in the liquid medium is preferably in a range of 0.1-20 mg/mL. The concentration range of GO in the ink enables thinner dry coatings for the smallest practical blade gap widths (about 1-10 μm) used during the mechanical removing of the excess ink on the surface of the porous substrate. The graphene oxide ink has a viscosity that enables subsequent mechanical removal of excess ink on the porous substrate. The viscosity of the ink is preferably in a range of 0.1 mPa*s to 10,000 m Pa*s, more preferably 1 mPa*s to 5000 mPa*s.

The liquid medium comprises a solvent. The solvent may be an aqueous solvent (e.g., water or aqueous solutions), an organic solvent or a mixture thereof. Organic solvents are preferably polar organic solvents. Organic solvents include, for example, alcohols (e.g., methanol, ethanol, n-propanol, i-propanol or mixtures thereof), N-methyl pyrolidinone (NMP), dimethylformamide (DMF), acetone, methylethyl ketone (MEK) or mixtures thereof. Ethanol is particularly preferred.

The ink may comprise additional ink components, for example, cross-linkers, viscosity modifiers, surface tension modifiers, defoamers, thixotrophy modifiers, binders or mixtures thereof.

An advantage of the present method is the ability to form GO films on a wide range of porous substrates. A porous substrate is a substrate having pores of sufficient size to permit the liquid medium to pass through the substrate under the influence of the pressure difference. The porous substrate preferably has pores that have diameters in a range of 1-1000 nm, more preferably 10-500 nm. The porous substrate may be symmetric or asymmetric with respect to pore size. A symmetric substrate has pores of similar diameters on opposed faces of the substrate, whereas an asymmetric substrate has pores of different diameter on one of the faces than the pores on the other of the faces. The porous substrate is preferably flexible. A flexible substrate preferably has a flexural modulus in a range of 0.05 GPa to 30 GPa, more preferably 0.5 GPa to 15 GPa. The porous substrate may comprise a single material or a plurality of layers and/or regions of different materials.

The porous substrate preferably comprises an organic polymer. The organic polymer may comprise a homopolymer, a copolymer, a terpolymer, or a mixture thereof. The organic polymer may comprise amorphous or crystalline polymers. The organic polymer may comprise hydrophobic or hydrophilic polymers. The organic polymer may comprise linear, branched, star, cross-linked or dendritic polymers or mixtures thereof. The organic polymer may be a thermoplastic, thermoset and/or elastomeric polymers. A given organic polymer may be classifiable into more than one of the foregoing categories.

Thermoplastic or elastomeric organic polymers are preferred. Thermoplastic organic polymers are particularly preferred. Thermoplastic organic polymers possess significant elasticity at room temperature and become viscous liquid-like materials at a higher temperature, this change being reversible. Some thermoplastic polymers have molecular structures that make it impossible for the polymer to crystallize while other thermoplastic polymers are capable of becoming crystalline or, rather, semi-crystalline. The former are amorphous thermoplastics while the latter are crystalline thermoplastics. Some suitable thermoplastic polymers include, for example, olefinics (i.e., polyolefins), vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof.

Some suitable olefinics (i.e., polyolefins) include, for example, polyethylenes (e.g., LDPE, HDPE, LLDPE, UHMWPE, XLPE, copolymers of ethylene with another monomer (e.g., ethylene-propylene copolymer)), polypropylene, polybutylene, polymethylpentene, or mixtures thereof. Some suitable vinylics include, for example, polyvinylchloride, chlorinated polyvinylchloride, vinyl chloride-based copolymers, polyvinylidenechloride, polyvinylacetate, polyvinylalcohol, polyvinyl aldehydics (e.g., polyvinylacetal), polyvinylalkylethers, polyvinylpyrrolidone, polyvinylcarbazole, polyvinylpyridine, or mixtures thereof. Some suitable styrenics include, for example, polystyrene, polyparamethylstyrene, polyalphamethylstyrene, high impact polystyrene, styrene-based copolymers, or mixtures Some suitable acrylonitrilics include, for example, polyacrylonitrile, thereof. polymethylacrylonitrile, acrylonitrle-based copolymers, or mixtures thereof. Some suitable acrylics include, for example, polyacrylicacid, polymethacrylicacid, polymethacrylate, polyethylacrylate, polybutylacrylate, polymethylmethacrylate, polyethylmethacrylate, cyanoacrylate resins, hydroxymethylmethacrylate, polacrylamide, or mixtures thereof. Some suitable cellulosics include, for example, cellulose, cellulose esters, cellulose acetates, mixed cellulosic organic esters, cellulose ethers, methylcellulose, ethylcellulose, carboxymethylcellulose, hydroxyethylcellulose, or mixtures thereof. Some suitable polyamides include, for example, aliphatic polyamides (i.e., nylons), aromatic polyamides, transparent polyamides, or mixtures thereof. Some suitable thermoplastic polyesters/polycarbonates are, for example, polyalkylene terephthalates (e.g., polyethylene terephthalate, polybutylene terephthalate), polycyclohexanedimethanol terephthalates, polyarylesters (e.g., polyarylates), polycarbonate, or mixtures thereof. Some suitable polysulfones include, for example, diphenylsulfone, polybisphenolsulfone, polyethersulfone, polyphenylethersulfones, or mixtures thereof. Some suitable polyimides include, for example, polyamideimide, polyetherimide, or mixtures thereof. Some suitable polyether/oxides include, for example, polymethyleneoxides, polyethyleneoxide, polypropyleneoxide, polyphenyleneoxides, or mixtures thereof. Some suitable polyketones include, for example, polyetheretherketone-1. Some suitable fluoropolymers include, for example, polytetrafluoroethylene, polychlorotrifluoroethylene, polyvinylfluoride, polyvinylidenefluoride, polyperfluoroalkoxy, polyhexafluoropropylene, polyhexafluoroisobutylene, fluoroplastic copolymers, or mixtures thereof.

Preferred examples of organic polymers include nylon, polyethylene terephthalate (PET), polypropylene (PP), polyacrylonitrile (PAN) polysulfone (PS), polyethersulfone (PES), polyvinylidene difluoride (PVDF), mixed cellulosic organic ester, cellulose acetate, thermoplastic polycarbonate (PC), thermoplastic polyester (PETE) or combinations thereof. Of particular interest are organic polymers useful in water vapor separation applications.

The graphene oxide ink is deposited on the porous substrate by dispensing the ink at a desired location on the porous substrate to form a pool of the GO ink on the porous substrate. A wet GO film with desired thickness is obtained by mechanically removing the excess wet GO film from the surface of the porous substrate while excess liquid is removed by providing a pressure difference that forces the liquid medium of the ink through the porous substrate to provide a GO film on the surface of the porous substrate. These two processes can be achieved spontaneously if the ink is dispensed via a slot-die or cascaded onto the substrate while a pressure difference is provided across the substrate. Mechanical removal of the excess ink may be accomplished using a casting method, for example tape casting, in which a scraping device (e.g., blade or die) is drawn through the pool of deposited ink. A green layer of the GO ink is so formed having a thickness dictated by a gap width between the scraping device and the surface of the substrate. The gap width may be adjustable by adjusting the height of the scraping device.

Deposition of a small volumetric loading of the ink per surface area of the substrate is useful so that there is not too much excess liquid to remove thereby increasing throughput. However, a large enough volumetric loading is desirable to ensure that a uniform film is formed. Therefore, a preferred volumetric loading of the ink on the substrate is in a range of 0.05 mL/in² to 10 mL/in², more preferably 0.5 mL/in² to 5 mL/mL/in², to enhance film uniformity for a desired film thickness. In some embodiments, the GO ink has a concentration of graphene oxide in a range of 0.1-20 mg/mL, more preferably 1-20 mg/mL. In some embodiments, the GO ink is deposited on the surface of the porous substrate in a volumetric loading sufficient to produce the GO film having a thickness in a range of 10 nm to 10,000 nm, more preferably 50 nm to 5,000 nm or 20 nm to 2,000 nm.

The pressure difference is produced by providing a region of pressure lower than atmospheric pressure on a surface of the substrate away from the surface on which the GO ink is deposited (i.e., vacuum-assisted) or by providing a region of pressure higher than atmospheric pressure on the surface of the substrate on which the GO ink is deposited (i.e., high-pressure assisted). A vacuum-assisted method is preferred. Preferably, the pressure difference provides a force of 175 N or more, more preferably 200 N or more to force the liquid medium through the porous substrate. In some embodiments, the force is preferably in a range of 175-1500 N, for example 200-1000 N. Commercial tape casting machines may be equipped with a vacuum bed that is generally utilized to hold a substrate flat during tape casting. However, the vacuum bed can be utilized in the present method to provide the necessary pressure difference.

During the formation of the GO film on the porous substrate, much of the liquid medium of the ink is forced through the porous substrate thereby being separated from the graphene oxide. However, the GO film can be further dried, if needed, to remove residual liquid medium. Drying is preferably performed at elevated temperature, for example in a drying oven. Drying temperature is preferably in a range of 20-200° C., more preferably 35-70° C., for example at about 60° C.

GO membranes comprising GO films having thicknesses in a range of 10 nm to 10,000 nm or preferably 20 nm to 2,000 nm can be produced. Such films provide excellent performance in applications requiring selective water transport. Selectivity of the GO membrane for water vapor permeance over nitrogen gas permeance is preferably at least 500, more preferably at least 1,000. In some embodiments, the selectivity is preferably in a range of 500-5,000, more preferably 1000-5,000.

The method may further comprise surface treating the GO film on the surface of the porous substrate. Surface treating may be performed to enhance adhesion and/or wettability of the membrane formed by the method, or for any other desired reason.

The present method provides an approach where GO dispersions can be continuously cast onto a porous substrate where the porous substrate is also held under a pressure difference, preferably a negative pressure with respect to the casting side of the porous substrate. The casting blade creates a thin film of the dispersion on the porous substrate and helps with shear alignment of the GO dispersions which shortens the time necessary for the liquid medium to filter through the substrate while the pressure differential induces a self-limiting flow. The method can produce large-area, continuous GO coatings of unlimited length on porous substrates. Thus, the present method is adaptable to continuous, roll-to-roll designs enabling higher throughput coatings compared to vacuum and pressure-assisted vacuum filtration. The present method provides an unparalleled combination of manufacturing throughput and water permeation and selectivity of the resulting GO film. The GO films are selectively highly permeable to water vapor and water-soluble gas molecules such as CO₂.

An advantage of the present method over both traditional tape casting and traditional vacuum filtration is the ability to simultaneously use less liquid medium while utilizing the self-limiting nature of filtration to help heal film defects during deposition of the GO film on the substrate leading to better selectivity. Further, traditional tape casting requires the ink to have high viscosity because low viscosity inks lead to massive shrinkage during drying causing film cracking and lead to leaking of the ink out of the blade or off the substrate. In the present method, the pressure differential applied through the porous substrate expands the viscosity range of the GO ink that can be used to form uniform GO coatings using tape casting.

### EXAMPLES

### Example 1: Production of Graphene Oxide (GO) Films

### Preparation of Graphene Oxide (GO)

Graphene oxide (GO) was prepared using Tour's improved Hummers' method (Marcano D C, et al. Improved Synthesis of Graphene Oxide. ACS Nano 2010, 4 (8), 4806-4814, the entire contents of which is herein incorporated by reference). In a typical reaction, a mixture of 360 mL of sulfuric acid (H₂SO₄) (Sigma-Aldrich, 95-98%), and 40 mL of phosphoric acid (H₃PO₄) (Sigma-Aldrich, extra pure, 85% solution in water) were added in a flask and stirred at room temperature. Then, 18 g of potassium permanganate (KMnO₄) (Sigma-Aldrich) was slowly added. The flask was then transferred into an oil bath. A hot plate was used to heat the oil bath and maintain the temperature of the mixture around 40° C. Once the temperature became stable, 3 g of graphite (Alfa Aesar, −10 mesh, 99.9%) was added and the temperature of the mixture was maintained between 45° C. and 50° C. After stirring for 16 h, the mixture was cooled down to room temperature. Finally, the mixture was slowly transferred into a large beaker filled with 400 g of ice. Once the mixture cooled down to room temperature, 5-7 mL of 30% hydrogen peroxide (H₂O₂) (Sigma-Aldrich) was slowly added until the colour of the solution turned from dark brown to golden. The resulting mixture was separated from the residual acids by centrifugation. The pellet was redispersed with 30% hydrochloric acid (HCl) (Sigma-Aldrich) and centrifuged again. This process was repeated once more, followed by four washes through centrifugation with ethanol (Fisher Scientific) to remove the HCl and other impurities. The resulting GO/ethanol stock was stored in a sealed jar away from light.

### Preparation of GO Ink

The GO/ethanol stock as-prepared above was diluted with ethanol to make a final GO ink at a desired concentration. Probe-sonication for 10 min was applied to ensure that the GO was dispersed as monolayer sheets in the ink.

### Preparation of GO Coating on Porous Substrate

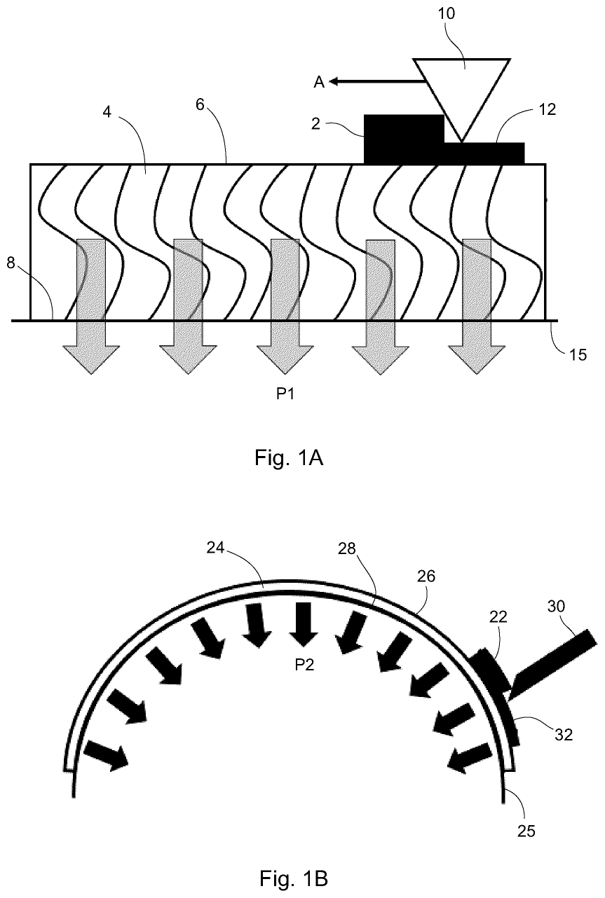

With reference to FIG. 1A and FIG. 1B, methods for preparing a GO coating on a porous substrate are illustrated for a flat substrate (FIG. 1A) and a curved substrate (FIG. 1B).

As seen in FIG. 1A, a flat porous substrate 4 is placed on a flat porous ceramic plate 15 and a GO ink 2 is deposited on an upper surface 6 proximate one end of the substrate 4. A scraping device 10 (e.g., tape caster, etc.) is drawn through the ink 2 in direction A while concurrently a negative pressure P1 is applied below the flat porous ceramic plate 15 below a lower surface 8 of the porous substrate 4. A thin film 12 of GO dispersion is formed in a gap between the scraping device 10 and the upper surface 6 of the porous substrate 4 as the scraping device 10 moves through the ink 2. The scraping device 10 can be drawn through the ink 2 by translating the scraping device 10 over the substrate 4 or by translating the substrate 4 under the scraping device 10. If the substrate 4 is moved, the method is capable of being used for continuous coating as is currently done in various tape casting systems, which are commercially available and capable of high throughput. While FIG. 1A is illustrated with a flat substrate, the same technique can be applied to a cylindrical substrate.

As seen in FIG. 1B, a curved porous substrate 24 is placed on a porous ceramic cylinder 25 and a GO ink 22 is deposited on an upper surface 26 of the substrate 24. A scraping device 30 (e.g., tape caster, slot-die, etc.) is drawn through the ink while concurrently a negative pressure P2 is applied in an interior of the cylindrical porous ceramic plate 25 below a lower surface 28 of the porous substrate 24. A thin film 32 of GO is formed in a gap between the scraping device 30 and the upper surface 26 of the porous substrate 24 as the scraping device 30 moves through the ink 22. The scraping device 30 can be drawn through the ink 22 by rotating the scraping device 30 around the substrate 24 or by rotating the substrate 24 under the scraping device 30. While FIG. 1B illustrates negative pressure in the interior of the curvature of the substrate, it is possible to utilize a tubular porous substrate and apply negative pressure outside the tube to be able coat the inner wall of the tubular porous substrate.

In both the method of FIG. 1A and FIG. 1B, negative pressure (with respect to atmospheric pressure) is created using a vacuum pump and needle valve to control the pressure to a desired pressure differential. The scraping device is placed in front of an ink dispenser with the gap size adjusted to be a desired value, for example 200 microns. The GO ink pre-loaded in the dispenser is dispensed over the porous substrate and the scraping device is moved over the dispensed ink at a desired speed (e.g., about 1 cm/s) to create a thin liquid film. Ideally, the GO ink used is in a liquid crystalline state and the shear induced from the gap is capable of aligning the sheets in the flow direction. Concurrent to tape casting, a vacuum is applied to the porous substrate, which draws liquid from the GO dispersion through the porous substrate, the liquid flow through the porous substrate further enhancing sheet alignment while the self-limiting nature of the pressure-assisted flow helping to heal defects in the GO film. The film can then be dried, preferably in an oven, to remove residual solvent and the dried film wound using conventional roll-to-roll processing approaches.

A vacuum-assisted doctor blade casting method in accordance with the method described above for flat porous substrates was used to cast GO films on three different porous substrates at four different pressure differentials, which have been normalized by coating area and reported as a force of 0 N, 155 N, 310 N and 851 N. The force of 0 N is a no-vacuum control that represents a standard doctor blading method. The three porous substrates were a nylon-based (nylon) substrate, a polypropylene (PP) substrate and a polyacrylonitrile (PAN) substrate. The nylon-based substrate comprised a layer of polyethylene terephthalate (PET) sandwiched between two layers of nylon 66. The nylon and PAN substrates are hydrophilic, the PP substrate is hydrophobic, and the PAN substrate is asymmetric having small pores on one side and bigger pores on the other side.

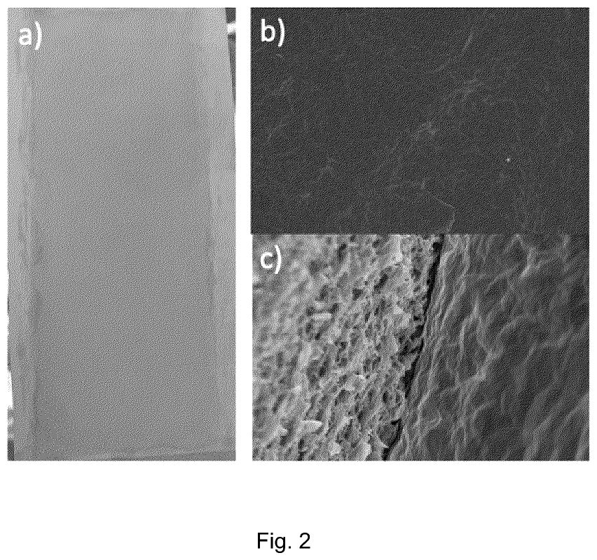

FIG. 2 depicts images of the GO film on the nylon-based substrate showing the very uniform morphology of the film. The SEM image in panel b) shows the very smooth GO coating while the SEM cross-sectional image in panel c) shows the smooth GO coating covering the rough porous nylon substrate. Self-limiting aspects of the vacuum-assisted doctor blading method helps heal defects in the film leading to very uniform film morphology, which contributes to higher selectivity.

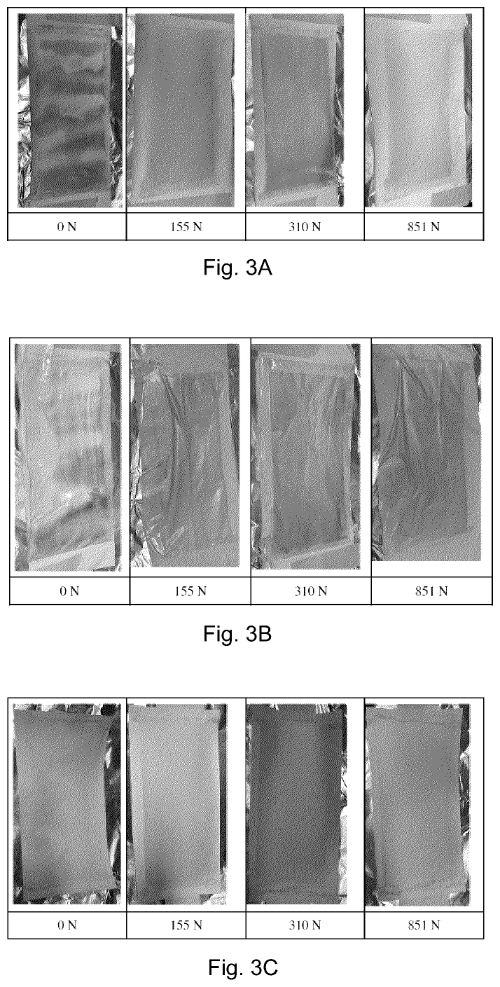

FIG. 3A, FIG. 3B and FIG. 3C demonstrate the necessity of applying a pressure differential during doctor blade casting to achieve uniform GO coatings on the various porous substrates. As shown in FIG. 3A, FIG. 3B and FIG. 3C, no matter which substrate is used, non-uniform coatings result when the coatings are prepared without applying a pressure difference (i.e., 0 N). All coatings were prepared by the same casting method and coating parameters/settings kept the same among all of the experiments except for the applied pressure difference.

### Example 2: Permeance and Selectivity of Graphene Oxide (GO) Films

### Measuring Water Vapor Permeance

Water vapor permeance is defined as the water vapor permeation rate per unit area per water vapor partial pressure difference across a membrane. In order to evaluate the water vapor permeance, as-prepared GO membranes comprising GO-coated porous substrates described above were placed in a custom-made test cell where a humid nitrogen stream was swept over the surface of the GO film and vacuum was applied on the other side of the membrane. This test cell was designed based on standards reported in the literature. By using this test cell, the water vapor permeance of the GO membrane can be quantified by:

$${W}_{perm} = \frac{{W}_{flux}}{Δ P \times A} \\ {W}_{flux} = {RH}_{0} \times {ρ}_{0}^{*} \times {V}_{feed} - {RH}_{1} \times {ρ}_{0}^{*} \times {V}_{retenate}$$

where Wₚₑᵣₘ represents the water vapor permeance across the GO coated membrane in the unit of mol·m⁻²·s⁻¹·Pa⁻¹; W_{flux} represents the water flux across the membrane in the unit of mol/s; RH₀ and RH₁ represent the relative humidity before and after applying vacuum on the retentate side, respectively, and it is measured using a humidity probe at the retentate side; V_{feed} and Vᵣₑₜₑₙₜₐₜₑ represent the volumetric flow rate in the unit of m³/s at the feed and retentate sides, respectively, which are measured using calibrated flow meters; ΔP is the difference of water vapor partial pressure across the membrane in the unit of Pa and A is the membrane area in the unit of m². ρ*₀ is the saturated vapor density at a specific temperature. The saturated water vapor density at temperature T, ρ*₀(T), can be calculated by:

$${ρ}_{0}^{*} ( T ) = 0.0022 \times \frac{{P}_{0 , water}}{273.15 + T} \\ {P}_{0 , water} ( T ) = 0.61121 \times exp [ ( 18.678 - \frac{T}{234.5} ) \times ( T234 \text{.5} + T ) ]$$

where P_{0,water} represents the saturated water pressure at temperature T (° C.) in the unit of Pa. The ΔP can be calculated by the equation shown here:

$$Δ P = {RH}_{0} * {P}_{0 , water} ( T ) - {P}_{perm}$$

where Pₚₑᵣₘ represents the water vapor partial pressure at the permeate side when vacuum is applied and it can be determined as the vacuum pressure difference measured using a 2 digit pressure gauge on the permeate side before and after the vacuum is applied.

### Measuring Hexane Vapor Permeance

Selectivity of water vapor over other gas/vapor can be determined by the ratio of water vapor permeance over gas/vapor permeance. Volatile organic solvent vapors, such as hexane and toluene, have been frequently used as the probe molecule to detect defects in porous selective membranes. Hexane has a vapor pressure as high as 17.6 kPa and a kinetic diameter of 0.43 nm which is slightly larger than that of N₂ (0.36 nm). Thus, hexane permeance is used to estimate the N₂ gas permeance and thus obtain the selectivity of water vapor over N₂ gas for the GO membranes.

An upright cup method was used to measure hexane vapor permeance across the GO membranes. This method is based on ASTM E95-96, a standard test method for water vapor transmission of material and has been used in literature for other vapors such as hexane. To measure the hexane vapor permeance, a cup is filled with hexane liquid and covered with the GO membrane with the edges sealed by Kapton™ tape and a center-opening lid. All the cups were placed in a well-ventilated area. In this case, the hexane vapor pressure inside the cup is 17.6 kPa vs. outside being approximately 0 kPa. The hexane vapor permeance, Hₚₑᵣₘ, in the unit of mol·m⁻²·s⁻¹·Pa⁻¹ can be calculated using the equation below:

$${H}_{perm} = \frac{{H}_{flux}}{Δ {P}_{hex} \times A}$$

where H_{flux} is the mass loss rate of hexane liquid inside the cup over time in the unit of mol/s; ΔPₕₑₓ is the partial pressure difference of hexane vapor across the membrane, which is 17.6 kPa; A is the GO membrane area in the unit of m².

To verify that hexane vapor permeance can be used to model N₂ permeance, a commercially available Nafion™ membrane was tested for water vapor permeance and hexane permeance using the methods described above. We found out that it has water vapor permeance of 5×10⁻⁶ mol·m⁻²·s⁻¹·Pa⁻¹ and an estimated selectivity of 16000. Both the permeance and selectivity values are in line with what had been reported in the literature. Thus, the selectivity of water vapor permeance over hexane vapor permeance can be used to estimate the selectivity of water vapor permeance over N₂ gas.

### Comparing Vacuum-Assisted Blade Casting to Traditional Blade Casting

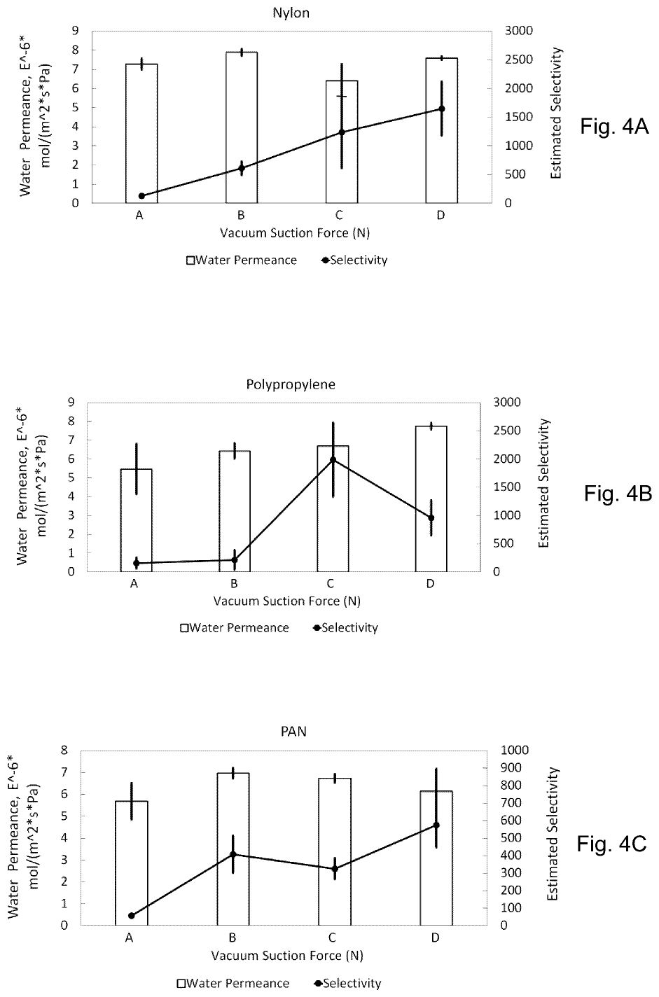

To compare water vapor permeance and selectivity of GO membranes made in accordance with a vacuum-assisted blade casting method to a GO membrane made by a traditional blade casting method, the water vapor permeance and selectivity were measured for each of the GO membranes illustrated in FIG. 3A, FIG. 3B and FIG. 3C. FIG. 4A, FIG. 4B and FIG. 4C show graphs of water permeance (left axis) and estimated selectivity (right axis) vs. suction force for the GO membranes, where A is the 0 N control sample, B is the 155 N sample, C is the 310 N sample and D is the 851 N sample. The water permeance is shown as a bar chart and the estimated selectivity is shown as a scatter plot. The results indicate that water permeance is relatively about the same for each sample, but that the estimated selectivity of water vapor permeance over N₂ gas significantly increases when a vacuum-assisted blade casting method is used (sample B, C and D) instead if a traditional blade casting method (control sample A) to produce the GO membranes. For nylon and PAN, the most significant increase in selectivity was observed when the GO coatings were prepared using suction force of 155 N or larger. For polypropylene (PP), the improvement is most significant when a vacuum suction of 310 N or larger was used.

### Comparing Vacuum-Assisted Blade Casting to Traditional Vacuum Filtration

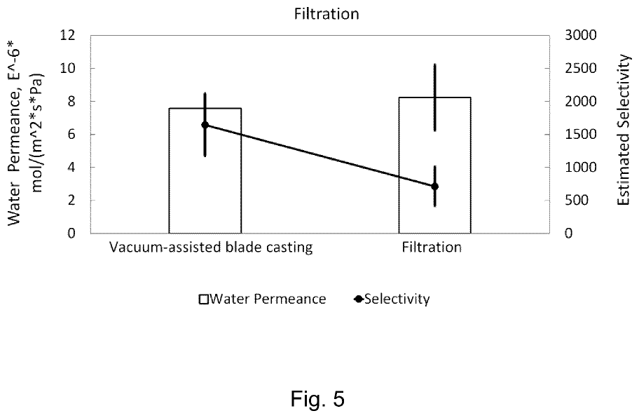

To compare water vapor permeance and selectivity of GO membranes made in accordance with a vacuum-assisted blade casting method to a GO membrane made by a traditional vacuum filtration method, nylon-based GO membranes were produced by both methods using the same suction force and the water vapor permeance and selectivity were measured for each of the GO membranes. FIG. 5 is a graph of water permeance (left axis) and estimated selectivity (right axis) for the nylon-based GO membranes that were produced. The water permeance is shown as a bar chart and the estimated selectivity is shown as a scatter plot. FIG. 5 shows that when compared to a GO film prepared by the traditional vacuum filtration process, the vacuum-assisted blade casting method achieves much better selectivity without causing any significant reduction in water permeability.

### Effect of GO Concentration in Vacuum-Assisted Blade Casting of GO Membranes

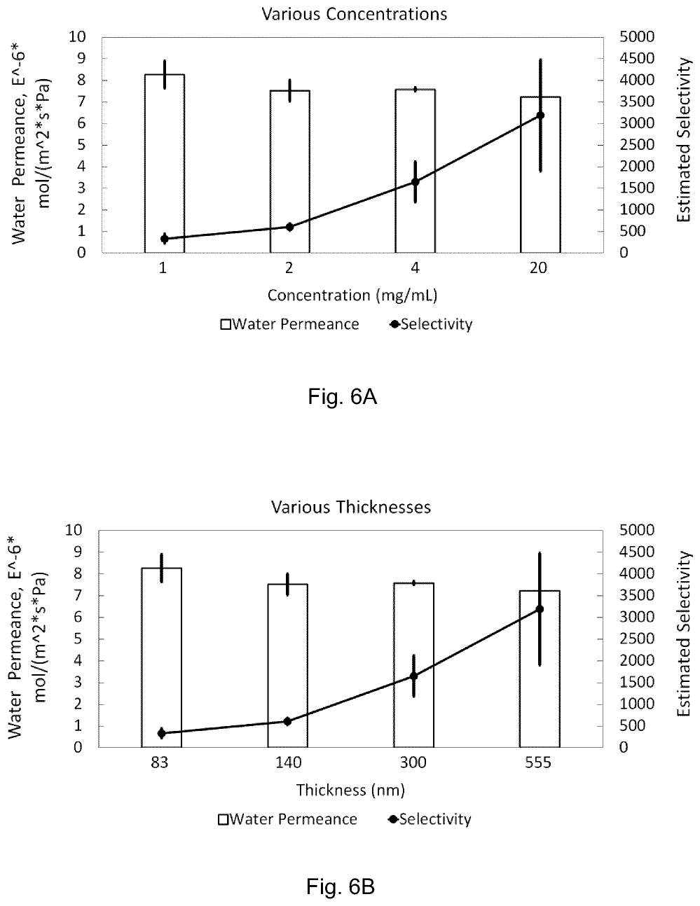

To determine the effect on water vapor permeance and selectivity on the concentration of graphene oxide (GO) in the ink, four ink samples were prepared in the same manner as described in Example 1 except that the four inks had GO concentrations of 1 mg/mL, 2 mg/mL, 4 mg/mL and 20 mg/mL, respectively. The four inks were used to prepare nylon-based GO membranes using vacuum-assisted blade casting as described in Example 1. The water permeance and selectivity of each GO membrane was measured and the results are shown in FIG. 6A and FIG. 6B. The 1, 2, 4 and 20 mg/mL inks result in coating thicknesses of about 80, 150, 300 and 550 nm, respectively, as determined by cross-sectional SEM. FIG. 6A plots the data with respect to GO concentration in the ink while FIG. 6B plots the data with respect to film thickness. FIG. 6A and FIG. 6B show that as the GO ink concentration increases, which results in an increase in coating thickness, a significant increase in selectivity is obtained with only a slight sacrifice in water permeability across the GO membrane. Further, the selectivity increases linearly with increasing GO concentration in the ink. Too high of a concentration may lead to a non-processable film.

GO Membranes with Various Substrates

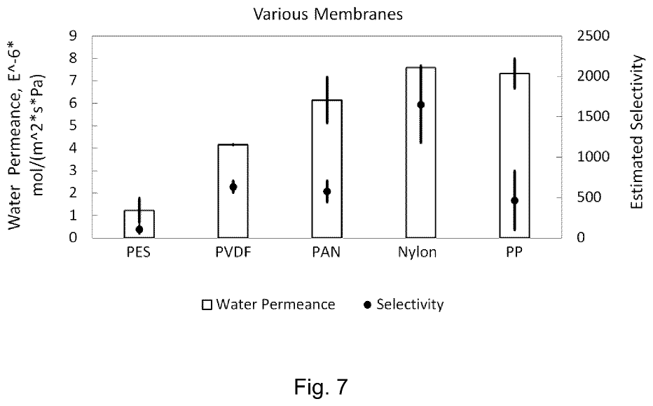

To determine the effect of substrate material on water vapor permeance and selectivity, five GO membranes were produced in the same manner as described in Example 1 except that five different organic polymer substrate materials were used. The five materials were a nylon-based (nylon) substrate, a polypropylene (PP) substrate, a polyacrylonitrile (PAN) substrate, a polyethersulfone (PES) and a polyvinylidene difluoride (PVDF). The nylon-based substrate comprised a layer of polyethylene terephthalate (PET) sandwiched between two layers of nylon 66. The nylon, PAN and PES substrates are hydrophilic, the PP and PVDF substrates are hydrophobic, and the PAN substrate is asymmetric having small pores on one side and bigger pores on the other side. FIG. 7 shows that the vacuum-assisted blade casting method can be extended to various substrates no matter whether they are symmetric or asymmetric, hydrophobic or hydrophilic, smooth or rough.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A method of forming a graphene oxide (GO) film on a substrate, the method comprising:
depositing a GO ink on a surface of a porous substrate; and,
mechanically removing excess ink on the surface of the porous substrate while simultaneously providing a pressure difference that forces a liquid medium of the ink through the porous substrate to provide a GO film on the surface of the porous substrate.

2. The method of claim 1, wherein:
the ink comprises a dispersion of graphene oxide in the liquid medium; and,
the excess ink is removed from a first surface of the porous substrate with a scraping device while simultaneously providing the pressure difference between the first surface and a second surface of the porous substrate to force the liquid medium through the porous substrate to provide the GO film on the first surface of the porous substrate.

3. The method of claim 1, wherein the GO ink is a liquid crystalline GO dispersion in the liquid medium.

4. The method of claim 1, wherein the liquid medium comprises a solvent.

5. The method of claim 4, wherein the solvent comprises ethanol.

6. The method of claim 1, wherein the ink further comprises cross-linkers, viscosity modifiers, surface tension modifiers, defoamers, thixotrophy modifiers, binders or mixtures thereof.

7. The method of claim 1, wherein the GO ink consists essentially of graphene oxide dispersed in ethanol.

8. The method of claim 1, wherein the pressure difference provides a force of 200 N or more to force the liquid medium through the porous substrate.

9. The method of claim 1, wherein the pressure difference is produced by providing a region of pressure lower than atmospheric pressure on a surface of the porous substrate away from the surface on which the GO ink is deposited.

10. The method of claim 1, wherein the GO ink has a concentration of graphene oxide in a range of 0.1-20 mg/mL and the GO ink is deposited on the surface of the porous substrate in a volumetric loading sufficient to produce the GO film having a thickness in a range of 10-10,000 nm.

11. The method of claim 1, wherein the GO ink has a concentration of graphene oxide in a range of 1-20 mg/ml and the GO ink is deposited on the surface of the porous substrate in a volumetric loading sufficient to produce the GO film having a thickness in a range of 50-5,000 nm.

12. The method of claim 1, wherein the porous substrate is flexible.

13. The method of claim 1, wherein the porous substrate comprises an organic polymer.

14. The method of claim 13, wherein the organic polymer comprises nylon, polyethylene terephthalate (PET), polypropylene (PP), polyacrylonitrile (PAN) polysulfone (PS), polyethersulfone (PES), polyvinylidene difluoride (PVDF), mixed cellulosic organic ester, cellulose acetate, thermoplastic polycarbonate (PC), thermoplastic polyester (PETE) or combinations thereof.

15. The method of claim 1, further comprising surface treating the GO film on the surface of the porous substrate.

16. The method of claim 15, wherein the surface treating enhances adhesion and/or wettability of a membrane formed by the method.

17. A membrane formed by the method of claim 1 comprising a graphene oxide (GO) film on a porous substrate.

18. The membrane of claim 17, wherein the porous substrate comprises an organic polymer, and the membrane has a selectivity for water vapor permeance over nitrogen gas permeance of at least 500.
